(19) United States
(12) Patent Application Publication
(10) Pub. No.: US 2008/0274666 A1
(43) Pub. Date: Nov. 6, 2008

(54) GAME CALL HOLDER

(76) Inventor: Brad Ray Weider, Bellevue, OH (US)

Correspondence Address: FRASER CLEMENS MARTIN & MILLER LLC, 28366 KENSINGTON LANE, PERRYSBURG, OH, 43551, US

(21) Appl. No.: 12/108,897

(22) Filed: Apr. 24, 2008

Related U.S. Application Data
(60) Provisional application No. 60/916,050, filed on May 4, 2007.

(51) Int. Cl. A01M 31/00; A63H 5/00; A45F 5/00

(52) U.S. Cl. 446/207; 224/578; 224/219

(57) ABSTRACT

A hands free game call holder for holding a game call is disclosed having an attachment member for securing the game call holder to a hand, an arm, or a wrist of a user. The game call holder includes a call securing member attached to the attachment member and adapted to removably receive the game call. A call plug is provided that militates against a flow of air through at least one aperture formed in the game call, wherein the game call can be operated while keeping the hands of the user free for other tasks.

### CROSS-REFERENCE TO RELATED APPLICATION

This application claims the benefit of U.S. provisional patent application Ser. No. 60/916,050, filed May 4, 2007.

### FIELD OF THE INVENTION

The present invention relates generally to a game call holder and more particularly to a game call holder which can be releasably attached to a wrist, hand, or an arm of a user and facilitates use of a can type game call while keeping hands of a user free for other tasks.

### BACKGROUND OF THE INVENTION

Game calls are used by hunters, photographers, and the like to create a selected sound to attract a targeted animal into a desired range. One type of call is a so-called “can” call such as the THE CAN® Model No. 711 produced by Primos, Inc. of Flora, Miss. The typical can call includes a cylindrical housing having a hollow interior and closed first and second ends. A piston, bellows, or other air operated member is slidably disposed in the interior of the housing and is adapted to simulate a deer bleat or other animal sound when operated. The first end of the housing includes a plurality of apertures formed therein which permit the sound to be emitted from the call. A single plug aperture is formed in the second end of the housing.

During operation, a user inverts the call to position the piston adjacent the first end of the housing. The user employs his or her finger or thumb to plug the aperture formed in the second end and then returns the call to an upright position. The piston is caused to slideably move toward the second end. Air disposed between the piston and the second end is caused to flow past the piston and create the sound emitted from the can. If the aperture formed in the second end is not plugged, the air will flow through the aperture rather than past the piston, and a sound is not emitted from the can.

The operation of the can typically results in the user not having both hands available for other tasks, one hand is employed to hold the can, selectively plug the aperture formed in the second end thereof, and rotate the can to create the desired animal sound. Because the one hand is operating the can, it is not available to operate a device such as a rifle, a bow, or a camera, for example. The operator typically must operate the can to attract the targeted animal into the desired range and then quickly release the can and grasp the device to take a shot, snap a picture, or the like. A time and a noise associated with releasing the can and grasping the device can cause the animal to move out of the desired range before the shot or the picture can be taken.

It would be desirable to produce a game call holder which attaches to a wrist, a hand, or an arm of a user, is easy to use, and facilitates use of a can type call while keeping both hands of the user free for other tasks.

### SUMMARY OF THE INVENTION

Compatible and attuned with the present invention, a game call holder which attaches to a wrist, a hand, or an arm of a user, is easy to use, and facilitates use of a can type call while keeping hands of the user free for other tasks, has surprisingly been discovered.

In one embodiment, a game call holder comprises an attachment member including a means for securing the attachment member in a desired position; a call securing member attached to the attachment member and adapted to removably receive a game call; and a call plug disposed on one of the attachment member and the call securing member and adapted to militate against a flow of air through an aperture formed in the game call.

In another embodiment, a game call holder comprises an elongate attachment member adapted to wrap around one of a hand, a wrist, and an arm of a user, and be secured in a desired position thereto, the attachment member including a hook and loop tape disposed thereon to facilitate securing the attachment member in the desired position; a call securing member formed from an elongate piece of an elastic material having opposing ends, each end fixedly attached to the attachment member to form an opening for removably receiving a game call; and a call plug disposed on one of the attachment member and the call securing member, the plug having a substantially frusto-conical shape adapted to be removably received by an aperture formed in the game call to militate against a flow of air therethrough.

In another embodiment a hands free device for emitting a sound to attract an animal comprises an elongate attachment member adapted to wrap around one of a hand, a wrist, and an arm of a user, and be secured in a desired position thereto, the attachment member including a hook and loop tape disposed thereon to facilitate securing the attachment member in the desired position; a call securing member formed from an elongate piece of an elastic material having opposing ends, each end fixedly attached to the attachment member to form an opening for removably receiving a game call; and a call plug disposed on one of the attachment member and the call securing member, the plug having a substantially frusto-conical shape adapted to be removably received by an aperture formed in the game call to militate against a flow of air therethrough, wherein a rotation of the arm causes an inversion of the device from the desired position to a position causing the slidable movement of the air operated member within the hollow interior of the game call, thereby facilitating the emitting of the simulated animal sound from the game call.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a game call holder according to an embodiment of the invention showing a call plug and a call securing member having a can type game call secured therein;

FIG. 2 is a top plan view of the game call holder illustrated in FIG. 1;

FIG. 3 is a bottom plan view of the game call holder illustrated in FIG. 1;

FIG. 4 is an enlarged fragmentary side elevational view of the call plug illustrated in FIGS. 1 and 2;

FIG. 5 is a fragmentary perspective view of a securing member according to another embodiment of the invention;

FIG. 6 is a fragmentary perspective view of a securing member according to another embodiment of the invention; and

FIG. 7 is a perspective view of the game call holder illustrated in FIGS. 1-3 showing a trigger mechanism attached thereto.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. It should be understood that throughout the drawings, corresponding reference numerals also indicate like or corresponding parts and features.

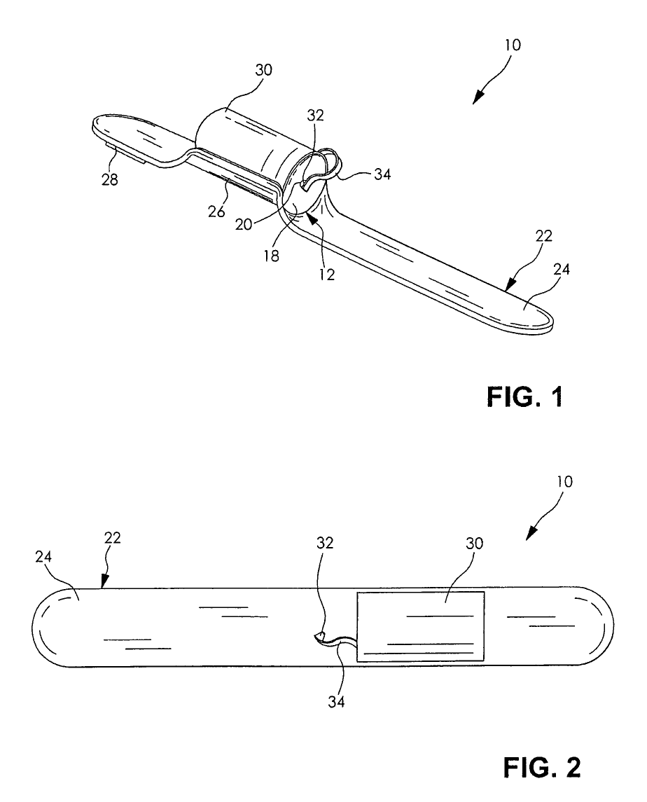

FIG. 1 shows a game call holder 10 according to an embodiment of the invention. The holder 10 is adapted to hold a game call 12 such as the THE CAN® Model No. 711 produced by Primos, Inc. of Flora, Miss. The game call 12 includes a generally cylindrical housing having a hollow interior, a closed first end (not shown), and a closed second end 18. A piston, bellows, or other air operated member (not shown) is slidably disposed in the interior of the housing and is adapted to simulate a deer bleat or other animal sound when operated. The first end of the housing includes a plurality of apertures formed therein which permit the sound to be emitted from the call 12. A single aperture 20 is formed in the second end 18 of the housing.

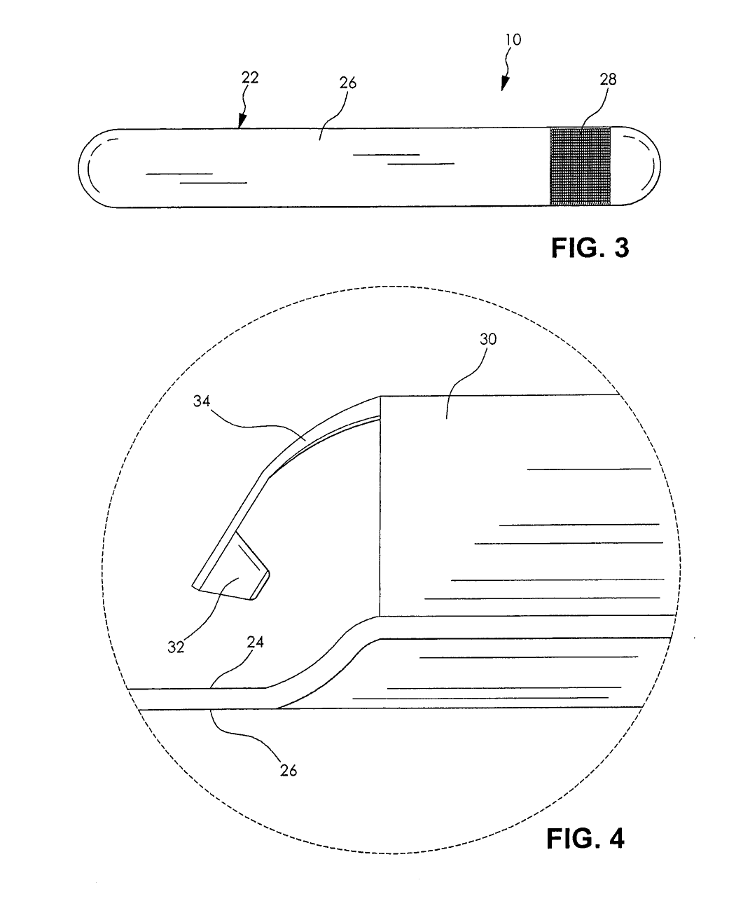

The holder 10, illustrated in FIGS. 2 to 4 without the game call 12, includes a flexible attachment member 22. The attachment member 22 has a generally elongate rectangular shape adapted to be wrapped around a wrist, a hand, or an arm of a user. The attachment member 22 includes a first surface 24 and a spaced apart second surface 26. The attachment member 22 includes securing means 28 to secure the attachment member 22 to the wrist, hand, or arm of the user at a desired location. In the illustrated embodiment, the securing means 28 is a hook tape disposed on the second surface 26 adjacent one end of the attachment member 22. The hook tape cooperates with a loop finish disposed on the first surface 24 to removably attach the hook tape thereto and secure the attachment member 22 around the wrist, the hand, or the arm of the user at the desired position. It should be understood that other securing means can be used as desired such as snaps, buckles, hooks, buttons, or the like, for example, without departing from the scope and spirit of the invention. The securing means 28 is disposed on the attachment member 22 such that the attachment member 22 is adjustable to various wrist, hand, and arm sizes of the user.

A call securing member 30 is fixedly attached to the attachment member 22. It should be understood that the call securing member 26 can be removably attached to the attachment member 22 as desired. Such removable attachment can be facilitated by any means now known or later developed, such as with hook and look tape or snaps, for example. The call securing member 30 is formed from an elongate stretchable or elastic material having opposing ends fixedly attached to the attachment member 22. It should be understood that the call securing member 30 can be formed from other materials as desired. Additionally, it should be understood that the call securing member 30 can be formed from two cooperating elongate pieces of stretchable or elastic material, wherein one end of each piece is attached to the attachment member 22, and opposite ends of each piece are adapted to be joined together with one of a hook and look tape, a snap, a buckle, a button, or the like to secure the game call 12 therein.

The call securing member 30 is adapted to secure the game call 12 to the attachment member 22 as illustrated in FIG. 1. It should be understood that the elastic material of the securing member 30 is adapted to accommodate game calls having shapes and dimensions different from the illustrated game call 12. Additionally, the shape or length of the securing member 30, as well as the orientation of the securing member 30 in respect of the attachment member 22, can be adapted to secure game calls having shapes and dimensions different from the illustrated game call 12.

A call plug 32, more clearly illustrated in FIG. 4, is adapted be removably received by the aperture 20 of the game call 12 to militate against the flow of air through the aperture 20. In the embodiment shown, the call plug 32 is formed from an elastomeric material and frusto-conical in shape. However, the call plug 32 can be formed form other materials and can have other shapes.

The call plug 32 is fixedly attached to the call securing member 30 with a flexible member 34. One end of the flexible member 34 is attached to the call securing member 30 employing an adhesive, a stitching, or a welding, for example. An opposite end of the flexible member 34 is formed integral with the call plug 32. In the illustrated embodiment, the flexible member 34 is formed from the same material as the call plug 32. It should be understood that the flexible member 34 may be formed from a material that is different from the call plug 32 such as a fabric or a cord, for example. Additionally, it should be understood that the flexible member 34 can be formed as a separate component from the call plug 32 and attached thereto. It should also be understood that the call plug 32 may be attached to the attachment member 22. Further, it should be understood that the call plug 32 can be removably attached to the call securing member 30 or the attachment member 22 employing a hook and loop tape, a snap, a button, a buckle, or the like at the one end of the flexible member 34, for example. It is also understood that the call plug 32 can be a separate component that is not attached to either the attachment member 22 or the call securing member 30 without departing from the scope and spirit of the invention.

In use, the call holder 10 is disposed in a desired position such as on the wrist of the user. The attachment member 22 is manipulated around the wrist of the user and the securing means 28 is employed to secure the call holder 10 in the desired position. The game call 12 is then disposed in the call securing member 30 and positioned so the call plug 32 can be inserted into the aperture 20 formed in the second end of the game call 12.

During conditions wherein operation of the game call 12 would be undesirable such as when transporting the game call 12, for example, the call plug 32 is removed from the aperture 20 formed in the game call 12. When a condition arises wherein normal operation of the game call 12 is desired, the call plug 32 is inserted into the aperture 20 formed in the game call 12. A rotation of the wrist of the user causes an inversion of the game call 12. Upon the inversion of the game call 12, the air operated member moves within the hollow interior of the game call 12 to the first end of the game call 12. Upon being moved back into the upright position by rotation of the wrist of the user, the air operated member slidably moves toward the second end 18 of the game call 12 causing the sound to be emitted from the apertures formed in the first end of the game call 12. The sound, which can be configured to mimic the sound emitted from animals, for example, can be used to attract the animals to move toward a desired location.

The call holder 10 can be quickly and easily assembled for use and can be used to cause the game call 12 to emit sound without the direct use of the hands of the user. Accordingly, the hands of the user are free to perform other tasks, such as manipulating a bow, a rifle, or a camera for example. Additionally, the call holder 10 enables the user to employ the game call 12 while minimizing a time and an undesired noise typically associated with the use thereof.

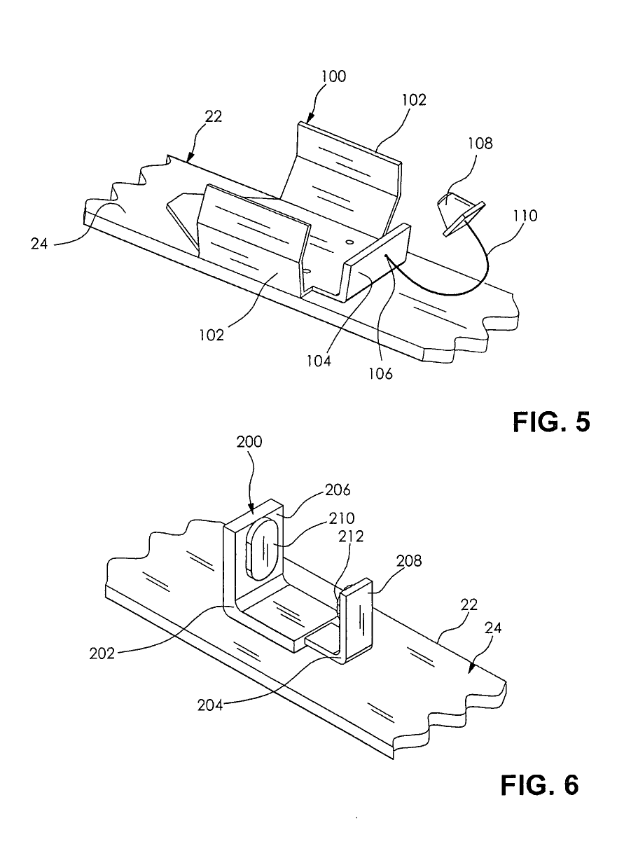

FIG. 5 shows the game call holder 10 having a call securing member 100 according to another embodiment of the invention. The call securing member 100 is fixedly attached to the first surface 24 of the attachment member 22. It should be understood that the call securing member 100 can be removably attached to the attachment member 22 as desired. The removable attachment can be facilitated by any means now known or later developed such as with hook and loop tape or snaps, for example.

The call securing member 100 is formed from a substantially rigid material, such as a metal or a molded resin, for example. It is understood that the call securing member 100 can be formed from other materials as desired. The call securing member 100 has a general u-shape cross-section that includes a pair of opposed walls 102. A tab 104 is formed in the call securing member 100. The tab 104 includes an aperture 106 formed therein. The walls 102 removably receive and secure the game call 12, therebetween. The tab 104 is adapted to abut the second end 18 of the game call 12 to facilitate positioning the game call 12 in a desired position and securing the game call 12 between the walls 102 of the call securing member 100. In the embodiment shown, a distance between the ends of the walls 102 is slightly smaller than a diameter or a width of the game call 12. It should be understood that the distance between the ends of the walls 102 can be selected as desired to accommodate receiving and securing a game call having a diameter or a width different from the game call 12.

A call plug 108 is fixedly attached to the call securing member 100. The call plug 108 is adapted to be removably received by the aperture 20 of the game call 12 to militate against the flow of air through the aperture 20. In the embodiment shown, the call plug 108 is formed from an elastomeric material and frusto-conical in shape. However, the call plug 108 can be formed form other materials and can have other shapes suitable to facilitate the call plug 108 substantially stopping the flow of air through the aperture 20 of the game call 12.

The call plug 108 is fixedly attached to the call securing member 100 with a flexible member 110. One end of the flexible member 110 is received in the aperture 106 formed in the tab 104 of the call securing member 100. It should be understood that the flexible member 110 may be secured to the tab 104 by forming a knot adjacent the one end of the flexible member, employing an adhesive, or other suitable means to secure the flexible member 110 to the tab 104. An opposite end of the flexible member 110 is formed integral with the call plug 108. In the illustrated embodiment, the flexible member 110 is formed from the same material as the call plug 108. It should be understood that the flexible member 110 may be formed from a material that is different from the call plug 108 such as a fabric or a cord, for example. Additionally, it should be understood that the flexible member 110 can be formed as a separate component from the call plug 108 and attached thereto. It should also be understood that the call plug 108 may be attached to the attachment member 22. Further, it should be understood that the call plug 108 can be removably attached to the call securing member 100 or the attachment member 22 employing a hook and loop tape, a snap, a button, a buckle, or the like at a the one end of the flexible member 110, for example. It is also understood that the call plug 110 can be a separate component that is not attached to either the attachment member 22 or the call securing member 100 without departing from the scope and spirit of the invention.

The remaining structure and use of the game call holder 10 having the call securing member 100 is as described above for the game call holder 10 illustrated in FIGS. 1-4.

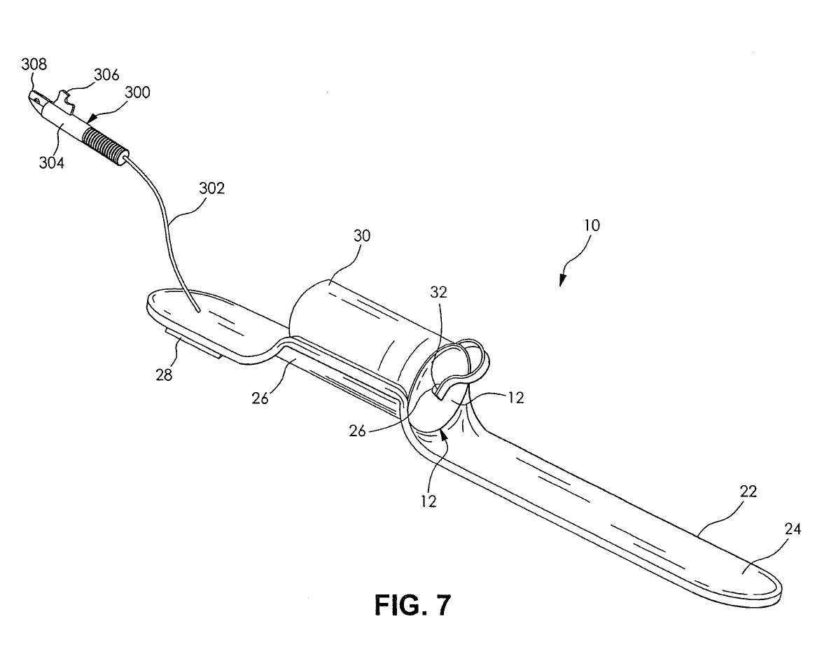

FIG. 6 shows the game call holder 10 having a call securing member 200 according to another embodiment of the invention. The call securing member 200 is fixedly attached to the first surface 24 of the attachment member 22. It should be understood that the call securing member 200 can be removably attached to the attachment member 22 as desired. Such removable attachment can be facilitated by any means now known or later developed, such as with hook and loop tape or snaps, for example.

The call securing member 200 is formed from a substantially rigid material such as a metal or a molded resin, for example. It is understood that the call securing member 200 can be formed from other materials as desired. The call securing member 200 includes a pair of opposing generally L-shaped gripping members 202, 204 each having a wall 206, 208, respectively. The gripping member 202 is fixed in respect of the attachment member 22, and is adapted to slidably receive a portion of the gripping member 204. The gripping member 204 can be positioned to locate the wall 208 at a selected distance from the wall 206. The positioning of the wall 204 facilitates compressively securing the game call 12 between the walls 206, 208.

The first gripping member 202 includes a grip 210 disposed on the wall 206 thereof. The grip 210 is adapted to abut the first end of the game call 12 and to facilitate securing the game call 12 within the call securing member 200. The gripping member 204 includes a plug 212 disposed on the wall 208 thereof. The plug 212 is adapted to militate against air flow through the aperture 20 formed in the second end 18 of the game call 12, and to facilitate securing the game call 12 within the call securing member 200. In the illustrated embodiment, the plug 212 is generally disk shaped. However, it should be understood that the plug 208 may have other shapes such as a frusto-conical shape to militate against air flow through the aperture 20 formed in the second end 18 of the game call 12. As shown, the grip 210 and the plug 212 are formed from a flexible or resilient substantially air impermeable material. However, it should be understood that the grip 210 and the plug 212 may be formed form other materials as desired.

The remaining structure and use of the game call holder 10 having the call securing member 200 is as described above for the game call holder 10 illustrated in FIGS. 1-4.

FIG. 7 shows the game call holder 10 including a trigger release 300 such as the T.R.U. Ball® Sniper trigger release produced by T.R.U. Ball of Madison Heights, Va. A flexible member 302 attaches the trigger release 300 to the attachment member 22. One end of the flexible member 302 is attached to the trigger release 300 and an opposite end of the flexible member 302 is attached to the attachment member 22. It should be understood that the ends of flexible member 302 may be fixedly attached or removably attached to the trigger release 300 and the attachment member 22, respectively, employing an adhesive, a stitching, a hook and loop tape, a snap, a buckle, or other suitable means as desired. It should also be understood that the trigger release 300 may be directly attached to the attachment member 22 without the aid of the flexible member 302.

The typical trigger release 300 includes a main body 304 having a trigger 306 an associated jaw member 308 disposed thereon. The jaw 308 is adapted to selectively secure and release a bow string upon the actuation of the trigger 306. The remaining structure of the game call holder 10 having the trigger release 300 is as described above for the game call holder 10 illustrated in FIGS. 1-4. It should be understood that the trigger release 300 can also be attached to the game call holder 10 having the call securing members 100, 200 illustrated in FIGS. 5 and 6, respectively.

In use the call holder 10 illustrated in FIG. 7 is disposed in a desired position such as on the wrist of the user with the game call 12 secured therein, as described above. The trigger release 300 is placed in a palm of, and gripped by, a hand that is adjacent the wrist to which the call holder 10 is attached. The jaw 308 of the trigger release 300 is caused to grip the bow string. The user exerts a pulling force on the main body 304 of the trigger release 300 which causes the jaw 308 to transfer the force to the bow sting and move the bow string to an extended position. While maintaining the bow string in the extended position, the user can pivot his or her wrist as described above to cause the game call 12 to emit a sound to attract a targeted animal toward a desired location or within a shooting range of the bow. Upon a desired release of a projectile from the bow such as an arrow, for example, the trigger 306 is actuated by the user. The actuation of the trigger 306 causes the jaw 308 to release the bow string allowing the bow string to move to the normal, relaxed position, and propel the projectile to move toward a selected target such as the targeted animal, for example.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A game call holder comprising:
an attachment member including a means for securing the attachment member in a desired position;
a call securing member attached to the attachment member and adapted to removably receive a game call; and
a call plug disposed on one of the attachment member and the call securing member and adapted to militate against a flow of air through an aperture formed in the game call.

2. The holder according to claim 1, wherein the attachment member is an elongate member adapted to be wrapped around and secured to one of a hand, a wrist, and an arm of a user.

3. The holder according to claim 1, wherein the means for securing the attachment member in a desired position is a hook and loop tape.

4. The holder according to claim 1, wherein the means for securing the attachment member in a desired position is at a least one of a snap, a buckle, a hook, and a button.

5. The holder according to claim 1, wherein the call securing member is fixedly attached to the attachment member.

6. The holder according to claim 1, wherein the call securing member is removably attached to the attachment member.

7. The holder according to claim 1, wherein the call securing member is formed from an elongate piece of an elastic material having opposing ends, each end attached to the attachment member to form an opening between the attachment member and the call securing member for removably receiving the game call.

8. The holder according to claim 1, wherein the call securing member includes a pair of opposed walls adapted to releasably receive the game call therebetween.

9. The holder according to claim 8, wherein the walls of the call securing member are adjustable L-shaped members for releasably receiving the game call therebetween.

10. The holder according to claim 9, including a grip disposed adjacent an end of one of the walls to facilitate securing the game call between the walls.

11. The holder according to claim 9, wherein the call plug is disposed adjacent an end of one of the walls.

12. The holder according to claim 1, wherein the call plug is adapted to be removably received by the aperture formed in the game call.

13. The holder according to claim 12, wherein the call plug has a substantially frusto-conical shape.

14. The holder according to claim 1, wherein the call plug is formed from an elastomeric material.

15. The holder according to claim 1, further comprising a flexible member disposed between the call plug and the one of the attachment member and the securing member.

16. The holder according to claim 1, further comprising a trigger release attached to the attachment member.

17. A game call holder comprising:
an elongate attachment member adapted to wrap around one of a hand, a wrist, and an arm of a user, and be secured in a desired position thereto, the attachment member including a hook and loop tape disposed thereon to facilitate securing the attachment member in the desired position;
a call securing member formed from an elongate piece of an elastic material having opposing ends, each end fixedly attached to the attachment member to form an opening for removably receiving a game call; and
a call plug disposed on one of the attachment member and the call securing member, the plug having a substantially frusto-conical shape adapted to be removably received by an aperture formed in the game call to militate against a flow of air therethrough.

18. The holder according to claim 17, further comprising a trigger release attached to the attachment member.

19. A hands free device for emitting a sound to attract an animal comprising:
an elongate attachment member adapted to wrap around one of a hand, a wrist, and an arm of a user, and be secured in a desired position thereto, the attachment member including a hook and loop tape disposed thereon to facilitate securing the attachment member in the desired position;
a call securing member formed from an elongate piece of an elastic material having opposing ends, each end fixedly attached to the attachment member to form an opening for removably receiving a game call; and
a call plug disposed on one of the attachment member and the call securing member, the plug having a substantially frusto-conical shape adapted to be removably received by an aperture formed in the game call to militate against a flow of air therethrough, wherein a rotation of the arm causes an inversion of the device from the desired position to a position causing the slidable movement of the air operated member within the hollow interior of the game call, thereby facilitating the emitting of the simulated animal sound from the game call.

20. The device according to claim 19, further comprising a trigger release attached to the attachment member.
